(19) United States
(12) Patent Application Publication
(10) Pub. No.: US 2008/0195540 A1
(43) Pub. Date: Aug. 14, 2008

(54) AUTOMATED TELLER MACHINE WITH FRAUD DETECTION SYSTEM

(75) Inventors: Steven Samuel Gee, Amarillo, TX (US); Robert A. Martin, Amarillo, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/675,022

(22) Filed: Feb. 14, 2007

(51) Int. Cl. G06Q 40/00

(52) U.S. Cl. 705/43; 235/379

(57) ABSTRACT

One embodiment involves a method for detecting fraud occurring at an Automatic Teller Machine (“ATM”). The ATM may include at least one cassette holding a denomination of paper currency to dispense. In one step, an ATM network host computer system receives a communications signal from the ATM. The signal comprises a transaction request to withdraw funds from the ATM by a user of the ATM. The communications signal also includes a transaction denomination value for the cassette holding the paper currency to dispense. The ATM network host computer system evaluates whether the transaction denomination value is different from an expected denomination value for the cassette. The transaction request is flagged if the transaction denomination value is different from the expected denomination value.

### CROSS-REFERENCES TO RELATED APPLICATIONS

This application is related to “ATM MACHINE AND METHODS WITH CURRENCY CONVERSION CAPABILITIES,” U.S. application Ser. No. 11/154,102, filed Jun. 15, 2005; “AUTOMATED TELLER MACHINE WITH RECEIPT PRINTER AND DISPLAY,” U.S. application Ser. No. 11/132,521, filed May 18, 2005; “EMERGENCY SERVICES NOTIFICATION FROM AN ATM SYSTEMS AND METHODS,” U.S. application Ser. No. 11/132,521, filed Sep. 22, 2006; “ATM CHECK INVALIDATION AND RETURN SYSTEMS AND METHODS,” U.S. application Ser. No. 11/253,340, filed Oct. 18, 2005; and “ATM SYSTEMS AND METHODS FOR CASHING CHECKS,” U.S. application Ser. No. 11/421,839, filed Jun. 2, 2006, the complete disclosures of which are herein incorporated by reference.

This application is also related to “MULTI-PURPOSE KIOSK AND METHODS,” U.S. application Ser. No. 10/225,410, filed Aug. 20, 2002, the complete disclosure of which is incorporated herein by reference.

### BACKGROUND OF THE INVENTION

Automatic Teller Machines (“ATMs”) are widely used by customers of financial institutions to perform transactions related to financial accounts. ATMs may be used for a variety of purposes, including the deposit or withdrawal of funds to such financial accounts. ATM's may also be used for credit card cash advances and other transactions, money transfers, payments (e.g., payment of a bill), balance inquiries, item purchase items (e.g., stamps), and other types of transactions involving the making and receiving of payments. One of the most common transactions involves the withdrawal of money from a checking or savings account. The customer may insert an ATM card and input a personal identification number (“PIN”), and may enter the desired withdrawal amount. If the transaction is approved, the requested amount is distributed. The withdrawal amount may then be deducted from the customer's account.

One issue with ATMs is that they can be prone to fraud. For example, some have learned how to reconfigure ATMs so that they dispense excessive funds. For example, instead of dispensing a single twenty dollar bill, the ATM may be manipulated so that it dispenses twenty twenty dollar bills, i.e. $400. This invention relates to techniques used to deal with such fraud.

### BRIEF SUMMARY OF THE INVENTION

One embodiment of the invention provides a method for detecting fraud occurring at an Automatic Teller Machine (“ATM”). The ATM may include at least one cassette holding a denomination of paper currency to dispense. In one step, an ATM network host computer system receives a communications signal from the ATM. The signal comprises a transaction request to withdraw funds from the ATM by a user of the ATM. The communications signal also includes a transaction denomination value for the cassette holding the paper currency to dispense. The ATM network host computer system evaluates whether the transaction denomination value is different from an expected denomination value for the cassette. The transaction request is flagged if the transaction denomination value is different from the expected denomination value. In this way, if an unauthorized reprogramming of the ATM occurs, such a change may be detected and flagged.

To evaluate the denomination value of the cassette, the host computer system may evaluate a previous transaction from the ATM to obtain the expected denomination value. In some cases, the host computer system may evaluate the communications signal to see if the transaction denomination value is missing. If a previous transaction contained a denomination value, the transaction may be flagged.

In some cases, a communications signal may be sent from the ATM network host computer system to the ATM to halt the transaction and disable the ATM. In other cases, instructions may be sent to the ATM to capture a presentation instrument used to initiate the transaction request.

In one particular aspect, the expected denomination value is $20. If this is changed to another value, the transaction may be flagged. Also, in some cases the ATM network host computer system may send a notification regarding a potentially fraudulent transaction. Such a notification may be to law enforcement, an email message or a message on a voice response system to notify an owner of the ATM. As another option, instructions may be transmitted to the ATM to capture an image of the user.

The invention also provides an exemplary system for detecting fraud occurring at an Automatic Teller Machine (“ATM”). The system includes an ATM having a cassette holding a denomination of paper currency to dispense. The ATM is configured to receive input from a user comprising a request to withdraw funds and to transmit a communications signal comprising a request to withdraw funds from the ATM by a user of the ATM. The communications signal includes a transaction denomination value for the cassette holding the paper currency to dispense. The system further includes an ATM network host computer system in communication with the ATM. The ATM network host computer system is configured to evaluate whether the transaction denomination value is different from an expected denomination value for the cassette. The host is also configured to flag the transaction request if the transaction denomination value is different from the expected denomination value.

In one aspect, the ATM network host computer system may be configured to evaluate a previous transaction from the ATM to obtain the expected denomination value. As an alternative, a communication signal may be evaluated to see if the transaction denomination value is missing. If previous transactions contained such a value, the transaction may be flagged.

In a further aspect, the ATM is further configured to delay dispensing of paper currency if the transaction denomination value is different from the expected denomination value. As another option, the ATM may be configured to capture a presentation instrument used to initiate the transaction request.

In some cases, the ATM network host computer system may further be configured to send a notification regarding a potentially fraudulent transaction. This may be to law enforcement by an email, phone call, fax or the like. As another option, the ATM network host computer system may be configured to transmit a message to a voice response system to notify an owner of the ATM. As another option, the ATM may be configured to capture an image of the user.

In a further embodiment, the invention provides an ATM network host computer system which includes at least one computer readable storage medium having at least one computer-readable program for operation of the computer system. The computer-readable program includes instructions to receive a communications signal from the ATM comprising a transaction request to withdraw funds from the ATM by a user of the ATM. The communications signal also includes a transaction denomination value for the cassette holding the paper currency to dispense. The program further includes instructions to evaluate whether the transaction denomination value is different from an expected denomination value for the cassette, and to flag the transaction request if the transaction denomination value is different from the expected denomination value.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a communications system that may be used to detect fraud occurring at an ATM according to various embodiments of the present invention.

FIG. 1B is a schematic diagram of an exemplary ATM that may be used according to various embodiments of the present invention.

FIG. 2 is a flow diagram that illustrates a method that may be used to detect fraudulent attacks on an ATM according to various embodiments of the present invention.

FIG. 3 is a schematic diagram that illustrates a representative device structure that may be used in various embodiments of the present invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following systems, methods, or software.

Systems, methods, and software are described for facilitating the detection and fraud occurring at an ATM. Such fraud may occur when a user re-programs the ATM to dispense improper denominations. Merely by way of example, the fraudster may configure the ATM so that the ATM believes it holds denominations that are different than it actually contains. Such bills are usually contained within cassettes as is known in the art. For instance, the ATM may think it holds one dollar bills when in fact it holds twenty dollar bills. As such, if a user requests $100, the ATM will dispense one hundred bills. However, these bills will be twenty dollar bills, making the total amount dispensed $2,000.

An incoming ATM transaction request can carry an extended message that contains unique information about the terminal, its state and a number of unique, detailed information items that vary by each brand of ATM. Some parts of these massages can be used to either directly read the cassette denomination that is in the ATM or can be used to calculate the denomination. When these transactions come in, a denomination fraud monitoring system parses the message and performs analysis on the message to determine if the terminal has been altered to dispense the wrong number of bills for the requested amount. At this time, the system performs a second analysis of possible actions to be performed, and based on those results, reacts in the proper manner.

According to certain embodiments of the invention, an ATM network host computer system may receive a request from the ATM to withdraw funds. Such a request may include an extended message that includes a transaction denomination value for the cassette holding the paper currency to dispense. The ATM network host computer system evaluates the request to see if the transaction denomination value is different than an expected denomination value for the cassette. If different, the transaction request may be flagged. Also, other courses of action may be taken, such as shutting down the ATM, capturing the user's card, taking an image of the user, sending an alert, such as to law enforcement, an owner of the ATM and the like.

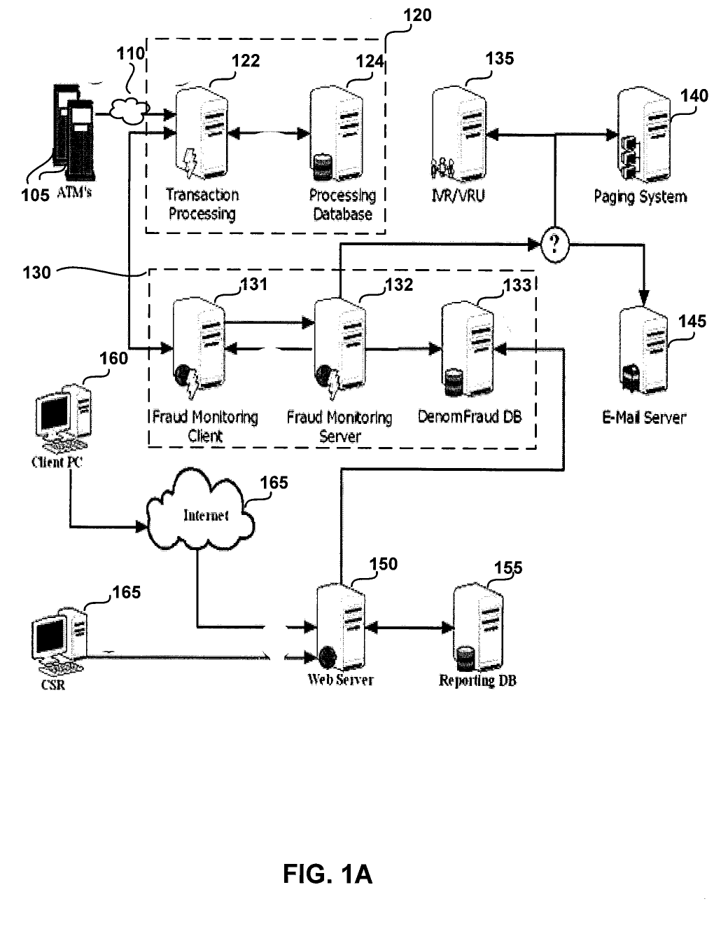

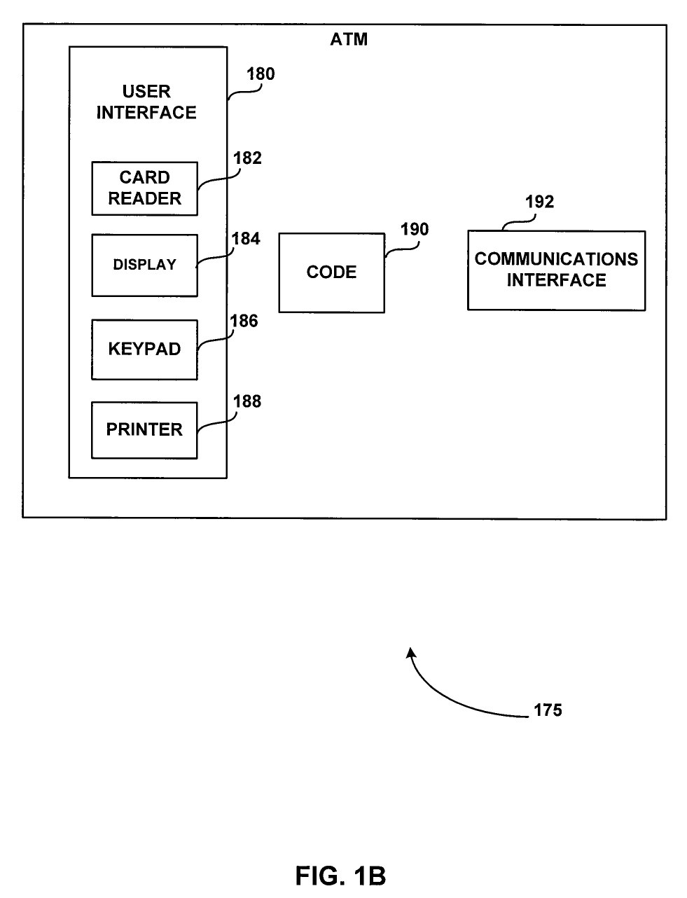

FIG. 1A illustrates an example of a system 100 within which various embodiments of the present invention may be included. System 100 components may be directly connected, or may be connected via a network, which may be any combination of the following: the Internet, an IP network, an intranet, a wide-area network (“WAN”), a local-area network (“LAN”), a virtual private network, the Public Switched Telephone Network (“PSTN”), an ATM network, or any other type of network supporting data communication between devices described herein, in different embodiments. The network may include both wired and wireless connections, including optical links. Many other examples are possible and apparent to those skilled in the art in light of this disclosure.

System 100 may include one or more ATMs 105. ATM 105 may comprise a machine, kiosk, or other apparatus which automatically dispenses cash upon certain user input and authentication procedures. FIG. 1B illustrates an exemplary block diagram 175 of an ATM 105 that may be used to dispense cash. ATM 105 may include a user interface 180 which may include multiple components, such as a card reader 182, display 184, keypad 186, and printer 188. Card reader 182 may be used to receive a card (e.g., ATM card, credit card, driver's license, smartcard, etc.) to obtain a financial account number, card number, or other identifier to identify the account for which the transaction will take place. A biometric input device may receive biometric information, and biometric authentication may be used in conjunction with, or in place of, a card reader. A variety of such biometric input devices are known in the art. Display 184 may be used to prompt a user for responses needed to perform a transaction, and to display information to the user.

Keypad 186 may be used to receive input from the user, such as a personal identification number (“PIN”) associated with the user's financial account, transaction selections, dollar amounts for transactions, and other information related to a user's transaction with the ATM 105. Keypad 186 (which may optionally comprise a touchscreen, either stand alone or a component of the display) may be used to receive input from a user when reconfiguring the ATM. User interface 180 may also include a printer 188 that may be used to print a receipt of a transaction. Other items, such as a microphone and speaker, or a video camera, may be integrated into or otherwise coupled with user interface 180.

ATM 105 may further include code (“ATM code”) 190 stored on a storage medium associated with the ATM 105, and such code may include programs or applications designed to implement methods of the invention. An ATM 105 may comprise a computing device, as described below, and, thus, may further include a processor and a communications interface 192. The ATM code 190 may be used to process a transaction or other request initiated by a user of the ATM 105. For example, ATM code 190 may be used when requesting to dispense funds, transfer funds between accounts, and the like. The ATM code 190 may direct the display to show inputs, to facilitate configuration of the ATM and the like. The ATM code 190 may encrypt or decrypt any portion of a communications signal to be sent or received. It should also be appreciated that in alternate embodiments, the ATM 105 may comprise fewer or additional components than described above.

System 100 further includes an ATM Network Host 120. ATM 105 communicates with ATM Network Host 120 over an ATM network 110 as is known in the art. By way of example, the ATM network 110 may comprise a network such as the NYCE® network, the Pulse® network, the STAR® network, and the like.

The communications interface 192 may be directly or indirectly communicatively coupled with ATM network 110 to provide for communication with an ATM Network Host 120. By way of example, the communications interface 192 may comprise a modem, a network interface card, or other wireless card connecting the ATM 105 to a phone line, a 4 wire dedicated phone line, a dedicated data line, a wireless network, an optical network, or other communication medium known in the art. ATM code 190 may use the communications interface 192 to communicate with the ATM Network Host 120 to thereby authenticate a user's financial account number and PIN, approve a transaction, or transmit a request for emergency services. Other information may also be requested and received using the communications interface 192. By way of example, two-way voice, text message, or other electronic communication between the ATM 105 and the emergency services provider 140 may be conducted via the communications interface 192 as well.

ATM Network Host Computer System 120 may include a transaction processor 122 and a processing database 124. However, ATM Network Host 120 may also include, for example, one or more server computers, workstations, web servers, or other suitable computing devices. The ATM Network Host 120 may be fully located within a single facility or distributed geographically, in which case a Network may be used to integrate different components. ATM Network Host 120 may comprise any computing device configured to process, manage, complete, analyze, or otherwise address a request to authenticate an ATM user, a request to process a transaction, a request to notify financial institutions or other systems of compromised accounts.

ATM Network Host 120 may include database 124 which maintains or otherwise stores information needed to process a transaction. Database 124 may comprise one or more different databases, which may be located within a single facility or distributed geographically, in which case a network may be used to integrate different components. According to different embodiments of the invention, database 124 may include any number of tables and sets of tables. One or more of the databases may be a relational database. The database 124 may be incorporated within the ATM Network Host 120 (e.g., within its storage media), or may be a part of a separate system. Database 124 may be organized in any manner different than described above to provide the functionality called for by the various embodiments, as known by those skilled in the art.

Application software running on the ATM Network Host 120 may receive a request to dispense funds, to perform balance inquiries to transfer funds between accounts, and the like. Also, ATM network host 120 may query a fraud monitoring system 130 to evaluate the denomination value of the ATM 105.

In some embodiments, ATM Network Host 120 receives a communications signal from the ATM 105. In some embodiments, the signal may comprise an encrypted, formatted message which includes an ATM card number, a personal identification number (“PIN”), and an identifier for the ATM 105. An “encrypted, formatted message” may include any formatted message in which any part of the message is encrypted. In some embodiments, only the PIN is encrypted. The request may also contain other information, such as the location of the ATM 105. The ATM Network Host 120 may decrypt the signal, and process the formatted message to determine whether the PIN matches the standard (i.e., traditional) PIN associated with the card number.

Fraud monitoring system 130 is employed to receive communication signals from ATM network host 120 to permit fraud monitoring system 130 to evaluate whether a transaction request from ATM 105 may be fraudulent. If not, fraud monitoring system 130 may send a communication back to ATM network host 120 so that normal processing of the transaction may occur.

Fraud monitoring system 130 may be constructed of a fraud monitoring client 131, a fraud monitoring server 132 and a fraud database 133. Fraud monitoring client 131 receives transactions from ATM network host 120 and performs an analysis to determine if possible denomination fraud has occurred. If so, fraud monitoring client 131 transmits a message to fraud monitoring server 132 which uses database 133 to determine a response to the possible fraud. The response may be based on client selected responses. If potential fraud is determined, fraud monitoring system 130 may take a variety of actions, including sending notifications back to ATM Network Host 120, communicating with an IVR/VRU system 135, a paging system 140 and/or an email server 145. These notifications may indicate probable fraudulent activity at ATM 105 and maybe used to notify a variety of individuals, such as the ATM owner, the account holder, or the like.

In order to configure various aspects of how potential fraud may be evaluated or how notifications may be transmitted, various interfaces to fraud monitoring system 130 may be provided. For example, a Web server 150 and an associated database 155 may be in communication with fraud monitoring system 130. Through this interface a personal computer 160 may communicate over the Internet 165 to access web server 150. Web server 150 may produce a web page on computer 160 which allows an ATM owner or financial institution to dictate what actions should be taken if potential fraud is determined. For example, the ATM owner could request that ATM 105 be shut down. Other options are to receive a notification from IVR/VRU 135, to receive a page on a mobile device from paging system 140 or receive an email from email server 145.

In some cases, a customer service representative (CSR) computer 165 may be used to access web server 150 and provide similar information. Other notification techniques that may be dictated include personal phone calls, faxes, and the like.

Messages passing between ATM 105 and ATM Network Host 120 may be formatted according to a certain format depending on a variety of factors. Such factors may include the manufacturer of the ATM, the type of financial or ATM network, the type of transaction and the like. Two examples of transaction messages are set for the below. The first is a Triton message and the second is a Cross/Tranx message.

Example of a Triton Message
\hat{ }BTRA703309990001\hat{ }\11\hat{ }\1570\hat{ }\5999999999999995=XXXXXXXXXX\hat{ }\00004000\hat{ }\00000200
\hat{ }\XXXXXXXXXXXXXXXX\hat{ }\\hat{ }\\hat{ }\KA-9988.02KT-9101.11KD01.09B45XX 0TXX00X000 000
02K0450030800001K03900398000010K010003060000 000\hat{ }\\hat{ }C\hat{ }R
Example of a Cross/Tranx message
\hat{ }BTRX703309990001\hat{ }\11\hat{ }\4245\hat{ }\5999999999999999998=XXXXXXXXXX\hat{ }\00020000\hat{ }\00000
250\hat{ }\XXXXXXXXXXXXXXXX\hat{ }\\hat{ }\\hat{ }\V01.00.10 V01.00.09 V01.00.05 0 0T 00 000
00000002K08000331003000000000000000000000000000000000000000000000\hat{ }\\hat{ }CG

Each of the messages contains information about where an account holder is requesting to perform a transaction. Each message also includes an extended portion identifying a denomination value for each of the cassettes. For example, the extended portion of the Triton message (‘02K0450030800001K03900398000010K010003060000’) has cassette values of $20 (02K), $10 (01K), and $100 (10K) for Cassettes 1, 2 and 3 respectively. In the above Triton example, the 5th field contains the requested amount (00004000) in the smallest unit of currency (pennies for the US). The request is for $40. The middle of the last field contains the currency denomination the machine is programmed with, again in the smallest unit of currency, with “k” representing 1,000. It is this extended message that may be tampered with or eliminated by unauthorized individuals.

The Cross/Tranx message follows the same rules as the Triton message. In the above example, the request is for $200 and the terminal is loaded with $20's. As described in greater detail hereinafter, it is the extended portion of the communication that may be evaluated to see if potential fraud has occurred.

Various actions may be dictated by ATM network host 120 once it has been notified of the fraud. In some embodiments, the ATM may delay dispensing the cash in response to a determination of probable fraud. A display may provide a message indicating, by way of example, “please wait” or “transaction processing.” Alternatively, in response to a detection of probable fraud, an ATM may activate a video camera, or take pictures with another camera, either of which may be communicatively coupled with the ATM 105 or ATM Network Host 120. In some cases, the ATM may transmit a signal that may be used to notify other financial institutions about the fraud. If the user has accounts with these financial institutions, such accounts may be treated according to pre-established rules. For example, the accounts may be frozen until released by the user or the value that may be withdrawn may be limited.

When potential fraud has been detected, a variety of systems may be used to provide notification as previously described. The transmission may comprise an electronic message, such as an e-mail or text message, or may comprise any other form of electronic message. The transmission may also comprise a telephone message from telephone voice response unit (“VRU”) 135. In such embodiments, fraud monitoring system 130 may communicate the requisite information to the VRU 125 in data form, and the VRU 125 may create an audio message based on the data. A number of such units are commercially available, and such technology is well known in the art. In still other embodiments, fraud monitoring system 130 may be in communication with a service center with human operators to contact the appropriate individuals to notify them of the potential fraud.

In some cases, the notification may involve contacting one or more financial institutions to notify those institutions of accounts that may have been involved. For example, account information may have been stolen and may be used to withdraw value from the associated accounts using altered ATMs. Based on the information provided by the financial institution, various actions may be taken in relation to the account. For instance, all funds associated with the account may be frozen until the user dictates otherwise, or they may be frozen for only a certain amount of time. As another option, only a certain portion of the funds may be available for withdrawal. In some cases, VRU 125 could call the ATM owner or the user (or a designee of the user) to make the notification. Other notification techniques include e-mail, fax, text messages and the like.

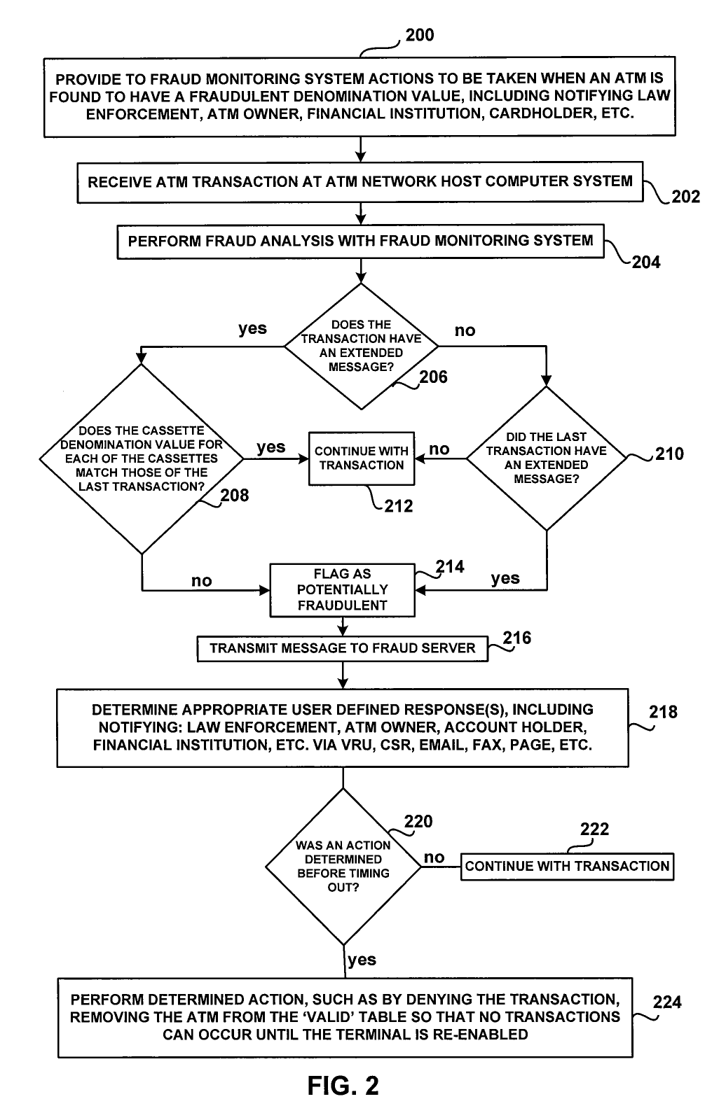

Referring now to FIG. 2, one exemplary method for detecting and dealing with potential denomination fraud will be described. Optionally, the fraud monitoring system may be initially configured as illustrated in step 200. The initial configuration can indicate which actions the fraud monitoring system should take if potential fraud is determined, as well as what checks should be performed when determining potential fraud. Actions to take can include notifying law enforcement, the ATM owner, the financial institution, the cardholder and the like. This information may be input via a web-interface from the ATM owner, a customer service representative or the like. In this way, the ATM owner may pre-set certain criteria for receiving a notice and to specify what actions are to be taken if potential fraud is detected.

The fraud detection techniques may be used with essentially any type of transactions performed at an ATM. Examples of transactions including cash withdrawals, funds transfers, balance inquiries, and the like. When the request is made at the ATM, it is transmitted to the ATM network host computer system as shown in step 202. The ATM network host computer system and/or the fraud monitoring system may evaluate the incoming transaction for possible denomination fraud as illustrated in step 204. A variety of techniques may be used to determine if the ATM has been tampered with. For example, the fraud monitoring system may evaluate whether the transaction has an extended message as shown in step 206. If it does not have an extended message, a look up may be performed to determine whether a previous message from that ATM contained an extended message as shown in step 210. This extended message may contain information on denomination values for each of the cassettes. If it did not have an extended message, then processing may continue as shown in step 212. However, if a previous transaction did have an extended message, then the transaction can be flagged as potentially fraudulent as shown in step 214. This is because someone may have accessed the ATM and removed the extended message, thus removing information on denominations for each of the cassettes.

Another check that may be performed is for the fraud monitoring system to evaluate whether the ATM cassette denomination value for each of the cassettes matches the last transaction as shown in step 208. If the cassette values match, processing of the requested transaction may continue as shown in step 212. If there are any discrepancies, the transaction may be flagged as potentially fraudulent as shown in step 212. This is because someone may have altered the cassette values since the last transaction.

For transactions that have been flagged as potentially fraudulent, a message may be transmitted to a fraud server of the fraud monitoring system as illustrated in step 216. The fraud server may then determine appropriate user defined response(s) using the fraud database. These may be those defined in step 200 or could be default values. Possible responses include sending notifications to law enforcement, to the ATM owner, to the account holder, to the financial institution, and the like. Further such notifications may be sent using a variety of formats, such as by a VRU, a CSR, an email, a fax, a page, a text message, and the like as shown in step 218.

In addition to transmitting the notification, the fraud monitoring server may determined whether any other actions should be taken as shown in step 220. If none is determined before timing out, such as after one second, then the transaction continues as normal as set forth in step 222. If a further action is determined, that action may be initiated by the fraud monitoring system as illustrated in step 224. Such actions may include denying the transaction, removing the ATM from the ‘valid’ table so that no transactions can occur until the terminal is re-enabled, and the like.

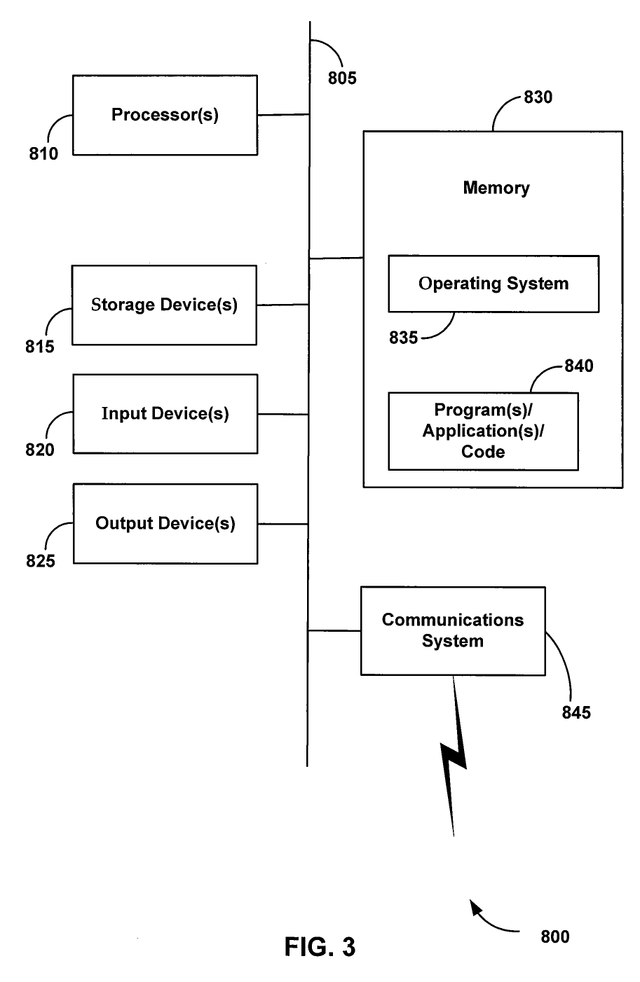

A device structure 600 that may be used for a computer, server, ATM network host computer system 120, PSAP, VRU, or other computing device described herein is illustrated with the schematic diagram of FIG. 3. This drawing broadly illustrates how individual system elements of each of the aforementioned devices may be implemented, whether in a separated or more integrated manner. The exemplary structure is shown comprised of hardware elements that are electrically coupled via bus 605, including processor(s) 610 (which may further comprise a DSP or special-purpose processor), storage device(s) 615, input device(s) 620, and output device(s) 625. The storage device(s) 615 may comprise a computer-readable storage media reader connected to any computer-readable storage medium, the combination comprehensively representing remote, local, fixed, or removable storage devices or storage media for temporarily or more permanently containing computer-readable information. The communications system 645 may comprise a wired, wireless, or other type of interfacing connection that permits data to be exchanged with other devices. The communications system(s) 645 may permit data to be exchanged with a network (including, without limitation, the Network 175).

The structure 600 may also comprise additional software elements, shown as being currently located within working memory 630, including an operating system 635 and other code 640, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

It should be noted that the methods, systems and devices discussed above are intended merely to be exemplary in nature. Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Also, it is worth noting that technology evolves, and that terms should be interpreted accordingly.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the terms “storage medium” or “storage device” may represent one or more devices for storing data, including read only memory (ROM), random access memory (RAM), magnetic RAM, core memory, magnetic disk storage mediums, optical storage mediums, flash memory devices or other machine readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A method for detecting fraud occurring at an Automatic Teller Machine (“ATM”) which includes at least one cassette holding a denomination of paper currency to dispense, the method comprising:
receiving, at an ATM network host computer system, a communications signal from the ATM comprising a transaction request to withdraw funds from the ATM by a user of the ATM, wherein the communications signal includes a transaction denomination value for the cassette holding the paper currency to dispense;
evaluating at a fraud monitoring system whether the transaction denomination value is different from an expected denomination value for the cassette; and
flagging the transaction request if the transaction denomination value is different from the expected denomination value.

2. The method of claim 1, wherein the evaluating step further comprises retrieving a previous transaction from the ATM to obtain the expected denomination value.

3. The method of claim 1, wherein the evaluating step comprises determining whether the transaction denomination value is missing from the communication signal.

4. The method of claim 1, further comprising sending a communications signal from the ATM network host computer system to the ATM to halt the transaction and disable the ATM.

5. The method of claim 1, wherein the communications signal sent to the ATM includes instructions to capture a presentation instrument used to initiate the transaction request.

6. The method of claim 1, wherein the expected denomination value is $20.

7. The method of claim 1, further comprising sending from the fraud monitoring system a notification regarding a potentially fraudulent transaction.

8. The method of claim 7, wherein the notification is transmitted to law enforcement.

9. The method of claim 7, wherein the notification comprises an email message.

10. The method of claim 7, wherein the notification comprises a message to a voice response system to notify an owner of the ATM.

11. The method of claim 1, further comprising transmitting instructions to the ATM to capture an image of the user.

12. A system for detecting fraud occurring at an Automatic Teller Machine (“ATM”) comprising:
an ATM having a cassette holding a denomination of paper currency to dispense, wherein the ATM is configured to:
receive input from a user comprising a request to withdraw funds; and
transmit a communications signal comprising a request to withdraw funds from the ATM by a user of the ATM, wherein the communications signal includes a transaction denomination value for the cassette holding the paper currency to dispense; and
an ATM network host computer system, in communication with the ATM, wherein the ATM network host computer system is configured to:
evaluate whether the transaction denomination value is different from an expected denomination value for the cassette; and
flag the transaction request if the transaction denomination value is different from the expected denomination value.

13. The system of claim 12, wherein the ATM network host computer system is further configured to evaluate a previous transaction from the ATM to obtain the expected denomination value.

14. The system of claim 12, wherein the ATM network host computer system is further configured to evaluate a previous transaction from the ATM to determine whether the transaction denomination value is missing from the communication signal.

15. The system of claim 12, wherein the ATM is further configured to delay dispensing of paper currency if the transaction denomination value is different from the expected denomination value.

16. The system of claim 12, wherein the ATM is further configured to capture a presentation instrument used to initiate the transaction request.

17. The system of claim 12, wherein the expected denomination value is $20.

18. The system of claim 12, wherein the ATM network host computer system is further configured to send a notification regarding a potentially fraudulent transaction.

19. The system of claim 18, wherein the ATM network host computer system is further configured to transmit the notification to law enforcement.

20. The system of claim 18, wherein the ATM network host computer system is further configured to transmit an email message with the notification.

21. The system of claim 18, wherein the ATM network host computer system is further configured to transmit a message to a voice response system to notify an owner of the ATM.

22. The system of claim 12, wherein the ATM is configured to capture an image of the user.

23. An ATM network host computer system, the system having at least one computer readable storage medium having at least one computer-readable program for operation of the computer system, wherein the computer-readable program includes instructions to:
receive a communications signal from the ATM comprising a transaction request to withdraw funds from the ATM by a user of the ATM, wherein the communications signal includes a transaction denomination value for the cassette holding the paper currency to dispense;
evaluate whether the transaction denomination value is different from an expected denomination value for the cassette; and
flag the transaction request if the transaction denomination value is different from the expected denomination value.
